(19) United States
(12) Patent Application Publication
(10) Pub. No.: US 2023/0174379 A1
(43) Pub. Date: Jun. 8, 2023

(54) PROCESS AND DEVICE FOR RECOVERING PHOSPHORUS FROM SEWAGE SLUDGE

(71) Applicant: GRENZEBACH BSH GmbH, Bad Hersfeld (DE)

(72) Inventor: Michael MEYER, Bad Hersfeld (DE)

(73) Assignee: GRENZEBACH BSH GmbH, Bad Hersfeld (DE)

(21) Appl. No.: 17/913,615

(22) PCT Filed: Mar. 30, 2021
(86) PCT No.: PCT/EP2021/025122

§ 371 Date: Sep. 22, 2022

(30) Foreign Application Priority Data
Mar. 30, 2020 (DE) 10 2020 001 989.7

(51) Int. Cl. C01B 25/12; C02F 11/10

(52) U.S. Cl. CPC C01B 25/12; C02F 11/10; C02F 2101/105

(57) ABSTRACT

A process for recovering phosphorus from sewage sludge in which sewage sludge undergoes a tumbling process in a rotary kiln and the expelled phosphor is collected in the form of a gaseous phosphorus pentoxide.

The invention relates to a method for obtaining phosphorus from sewage sludge according to the preamble of patent claim 1.

EP 2 160 438 B1 discloses a process for the preparation of phosphorus pentoxide (P₂O₅), which is based on a process originally invented by Robert A. Hard, which is therefore also referred to by its inventor as Hard's process. The method comprises forming a furnace bed using feed agglomerates in a countercurrent rotary kiln. The agglomerates contain phosphate ore particles, carbonaceous material particles and sufficient silica particles. In this case, the agglomerates should have a calcium-to-silicon dioxide molar ratio of less than 1,0, wherein individual agglomerates essentially have the same elemental composition, the same calcium-to-silicon dioxide molar ratio and the same proportion of excess solid carbon in comparison with a theoretical carbon requirement for the reduction of the total phosphate in the ore. When carrying out the process, a bed temperature is maintained at or above 1180° C. along a portion of the bed length. A furnace exhaust gas is produced, wherein phosphorus pentoxide is simultaneously obtained from the furnace exhaust gas, the furnace leaving a residue containing processed agglomerates, with less than 10% of the phosphate entry of the agglomerates remaining in the furnace as phosphate in the residue.

According to the Regulation on the Utilization of Sewage Sludge, Sewage Sludge Mixtures and Sewage Sludge Compost (Sewage Sludge Ordinance— AbfKlärV [Germany]), a reorganization of sewage sludge treatment as well as disposal in Germany is aimed at. In particular, the ordinance aims to return phosphorus to the economic cycle (Bundesgesetzblatt (Federal Law Gazette) 27.09.2017 [Germany]).

According to this amended version of the Sewage Sludge Ordinance, phosphorus recovery is provided for phosphorus contents of more than 20 g/kg dry matter sewage sludge. This limit value is mandatory for treatment plants with a size of more than 100,000 down to a size of 50,000 population equivalents, after a transition period of 12 or 15 years. For treatment plants for population equivalents of less than 50,000 and phosphorus concentrations of less than 20 g/kg dry matter sewage sludge, soil-related recycling is permitted for an unlimited period (Bundesgesetzblatt (Federal Law Gazette) 27.09.2017 [Germany]).

Starting point for the recycling of the phosphorus is the annual phosphorus load of municipal sewage treatment plants of 61,000 t/a Here, different material streams which arise during the treatment of the waste water are considered. In this case, a distinction is made between waste water (sewage treatment plant flow), process water (sludge water), sewage sludge and sewage sludge ashes. All said approaches are available for possible recovery of the phosphorus, but the highest phosphorus concentrations are found in the dewatered sewage sludge and the sewage sludge ashes.

The current utilization situation of sewage sludge in Germany is characterized above all by thermal disposal. The agricultural utilization represents the second largest disposal path.

As a result of the new Regulation [Germany], the proportion of sewage sludge that can be used in agriculture is severely restricted. Therefore, phosphorus recovery processes that start with raw sludge, digested sewage sludge and sewage sludge ash are becoming increasingly important.

In the waste water of sewage treatment plants, the phosphorus occurs most frequently as orthophosphate (PO₄³⁻) in anionic form. In addition, organically bound phosphorus and polyphosphates exist. Both the organically bound phosphorus and the polyphosphates can be mineralized or hydrolyzed by microorganisms to give orthophosphate.

The organically bound phosphorus is in particular biologically bonded phosphorus. This form is found again in the biological waste.

Under anaerobic conditions, bacteria use the phosphorus storage (polyphosphates) stored in their cell mass as an energy source. If the bacteria are again in the aerobic environment, they again take dissolved phosphates.

In sewage treatment plants, in the process step of phosphorus elimination, the phosphate is bound by means of precipitants such as aluminum salts or iron salts and lime. As a result, the phosphates initially dissolved in the water are chemically bound in the form of insoluble salts.

Depending on the locations of the removal points, the recovery potentials as well as the type of phosphorus compound differ. In the course of the clarification plant, the phosphorus is present in dissolved form as orthophosphate. In the case of recovery via the sludge water, the recovery degree depends strongly on the operating mode of the waste water purification system. For the greatest possible recovery, the feed points are suitable after dewatering and thermal utilization. There, the phosphorus is present biologically and chemically bound in the sludge matrix. For recovery, however, it must be redissolved. After thermal utilization, usually by a monocombustion plant, the phosphorus is present chemically bound in the sewage sludge ash.

Due to the significant loss of mass during the combustion of the sewage sludge, a higher concentration of phosphorus in the sewage sludge ash is achieved. Thus, the sewage sludge ash has the highest phosphorus content compared to the other forms of residues.

In the process water of the wastewater treatment plants, the dissolved phosphorus accumulates in the sewage sludge by precipitation and deposition. In the subsequent dewatering, 50 to 80% of the water is deposited.

Depending on the type of metering points, three types of treatment methods can be distinguished. In the pre-precipitation, the precipitant is pre-precipitated before the settling basin. In general, almost all precipitating agents can be used.

In simultaneous precipitation, the precipitant is added before, after or directly into the aeration tank. In this treatment process, iron (III) salts are preferably used, but aluminum (III) salts and iron (II) salts are also possible. Simultaneous precipitation represents an immediate measure for phosphorus elimination, after which the precipitated phosphorus is removed with the excess sludge.

The secondary precipitation is an independent precipitation stage installed downstream of the secondary clarifiers. In this process, additional reaction tanks such as flocculation tanks are required in addition to dosing and mixing equipment. All precipitants can be used in this process, but the consumption is significantly higher than in the other treatment processes.

Trivalent iron Fe³⁺ is used as iron chloride (FeCl₃) or iron (III) sulfate Feₑ (SO₄)₃. Furthermore, divalent iron can also be used as iron sulfate FeSO₄ (green salt), which is only oxidized by reaction with oxygen to form Fe₃₊.

4 Fe²⁺+O₂+4 H⁺→4 Fe³⁺+2 H₂O

These precipitants form sparingly soluble iron phosphate FePO₄, which improves the flake formation and the settling properties. At the same time, the precipitating agent also leads to the elimination of polyphosphates and organic phosphorus.

FeCl₃+PO₄³⁻→FePO₄+3 Cl⁻

Fe₂(SO₄)₃+2 PO₄³→2 FePO₄+3 SO₄²⁻

In the form of aluminum sulfate Al2 (SO₄)₃ 18 H₂O, the phosphorus present is precipitated by means of Al³⁺. The trivalent aluminum ion forms readily deposited flakes and is therefore often used in the corresponding treatment process.

Al₂(SO₄)₃+18 H₂O+2 PO₄³→2 AlPO₄+3 SO₄²⁻+18 H₂O

During the lime-phosphate precipitation, a softening process of the waste water is initiated with calcium hydroxide, resulting in a precipitation of calcium carbonate. The calcium phosphate precipitation only starts when 60 to 80% of the calcium carbonate has been formed.

3 Ca(OH)₂+2 PO₄³⁻→Ca₃(PO₄)₂+6 OH

The precipitation with lime milk is made more difficult by the problems of the high sludge incidence and lime precipitation in the pipelines of the sludge treatment plant. Phosphorus can be found in various fractions of the waste water purification plant. Thus, the phosphorus load in the material streams under consideration also differs.

There are various phosphorus recycling processes which are operated on a large scale. These are, in particular, thermochemical and metallurgical methods.

DE 102 43 840 B4 discloses a method for separating heavy metals from phosphate-containing sewage sludge ash. In this case, alkali metal chlorides and/or alkaline earth chlorides are mixed into the ash. The mixture is then heated above the boiling point of the forming chlorides of the heavy metals in a closed system, for example in a rotary kiln. The heavy metal chlorides emerging from the mixture, such as cadmium, copper, mercury, lead, molybdenum, tin and zinc, are formed from volatile metal chlorides and oxide chlorides, which volatilize from the ash into the exhaust gas, are then collected separately.

The current industrial application provides the use of sodium sulfate as an additive to ash. In this case, rhenanite (CaNaPO₄) is intended to represent the main component of the mineral phosphorus stage, which is also available as a phosphorus fertilizer. The process is based on the calcination of the phosphorus; sodium sulfate, sewage sludge as dry matter and ash from a hot gas cyclone are added and treated at 900 to 1000° C. in a vented rotary kiln. After the thermochemical treatment, the product is granulated and dried. The resulting exhaust gas, which contains, inter alia, the heavy metals, is prepared via a plurality of steps in an exhaust gas purification (cf. Schaaf, T. Hermann, L. (2016): Process for the production of fertilizer from sewage sludge ash-ASH DEC process. Hg v Outotec GMBH & Co KG. Essen. Online available under https://environmental hessen.de/sites/default/files/media/huelv/10 impulsvortrag_ash_decverfahrenen.pdf: Adam, C; Peplinski, B; Michaelis, M; Kley, G; Simon, F-G (2009): Thermochemical treatment of seaweed sludge ashes for phosphorus recovery. In: Waste management (New York, N.Y.) 29 (3), p. 1122 to 1128. DOI: 10.1016/j.wasman.2008.09. 011; Stemann, Jan. Peplinski, Burkhard; Adam, Christian (2015): Thermochemical treatment of seaweed sludge ash with sodium salt additives for phosphorescence fertilized production-analysis of unknown chemical reactions. In: Waste management (New York, N.Y.) 45, pages 385-390. DOI: 10.1016/j.was.2015.07.029).

A metallurgical phosphorus recycling is also known from EP 2 874 763 B1, which combines the material and energy utilization of phosphate-containing waste. For this purpose, sewage sludge and sewage sludge ash are pressed into briquettes and mixed with limestone and foundry coke. The coke is intended to provide the required thermal energy and contribute to the reducing atmosphere in the furnace shaft. The mineral constituents of the sewage sludge are used, for example, in a cupola furnace at 1,450 to 2,000° C. to form a slag. Volatile heavy metals evaporate in the shaft of the furnace and are deposited in the gas purification. The synthesis gas formed under these temperatures can be used energetically together with the waste heat. At higher temperatures, the remaining metals melt and form an iron-rich slag which collects due to the higher density in the hearth of the furnace. Phosphorus-rich liquid slag, which is located above the molten metal in the furnace hearth, is separated from the iron-rich melt by cutting at different heights. This process can thus recover a phosphate-containing slag, an iron-rich metal alloy, and the synthesis gas as a by-product. It is known that the phosphorus is distributed differently in the products obtained. Thus, the phosphorus is again found in the iron tapping as well as in the filter dust. A phosphorus content of only 2.2 to 2.5% by mass is achieved in the granulated slag.

In a further known thermal process for recycling phosphorus, elemental phosphorus is obtained as P2 from sewage sludge ashes at temperatures of at least 1,500° C. under reducing conditions and then reacted to form phosphoric acid.

In another known thermal process, it is possible through the use of a rotary kiln to produce phosphorus pentoxide over two zones. The formation of melts can be prevented by a sufficient addition of silicic acid. Carbon monoxide forms in a first reducing zone:

2 Ca₃(PO₄)₂+6 SiO₂+10 C→6 CaSiO₃+10 CO+P₄

In a second oxidizing zone, afterburning takes place in the gas phase:

P₄+5 O₂→2 P₂O₅

CO+½ O₂→CO₂

In a downstream exhaust gas purification, the gas is dedusted in a cyclone. The phosphorus pentoxide is then absorbed in a scrubber to form phosphoric acid.

According to WO 2005/118468 A2, U.S. Pat. No. 7,378,070 B2, U.S. 7,910,080 B2, US 2013/0136682 A1 and US 2016/0090305 A1, this method was improved.

A high temperature reaction is disclosed that proceeds within the furnace bed:

Ca₁₀(PO₄)₆F₂+9 SiO₂+15C→3 P₂↑+15 CO ↑+9 CaSiO₃+CaF₂

For the reaction shown, it is advantageous if a uniform temperature profile with sufficient exposure times is maintained. A minimum temperature of 1,180° C. is mentioned, but a temperature of 1,225 to 1,250° C. is recommended. As shown in the reaction equation, the carbon should be present in reactive form with a molar ratio of C: P of at least 2.5. In order to displace the chemical equilibrium on the side of the products, the carbon should be present superstoichiometrically in relation to phosphorus. Furthermore, the formation of iron phosphides is described in connection with the complete removal of the phosphorus from the furnace load. If fluoroapatite is reduced, phosphorus-metal vapor and carbon monoxide are produced as vapor-or gaseous reaction products. When the atmospheric pressure is exceeded, the gas mixture escapes from the pellets into the surrounding furnace atmosphere (in principle the furnace is operated at atmospheric pressure). The remaining phosphorus in the residue of the pellets is completely bound to iron in the form of FeP and Fe₂P.

It is the object of the invention to provide a process for obtaining phosphorus from sewage sludge.

This object is achieved, as indicated in patent claim 1.

According to the invention, it has been found that it is possible to transfer Hard's process, as is evident from the above-identified patent documents, to the use in sewage sludge.

The sewage sludge is previously mechanically dewatered. Depending on the chemical composition of the sewage sludge, it may be necessary to add and mix finely ground quartz sand with a grain size of less than 100 μm. The stoichiometric ratio of the reactants phosphorus (P), carbon (C) and silicon dioxide (S102) is: P: C: SiO₂=2: 5: 3 (molar) or P : C : SiO₂≈1:3:5 (according to mass fractions) must be changed for a technical process to the effect that all reactants other than the target element are superstoichiometric amounts to be added to maximize phosphorus yield. Experience in the recovery of phosphorus has shown that carbon with a factor of 3 and S102 with a factor of 1, 7 are to be used superstoichiometrically. Thus, the real ratio of the starting materials P: C: S102^{\tilde{ }}1: 3: 5 is to be regarded as a standard mixing ratio after mass fractions. In practice, a superstoichiometric carbon fraction is present in the sewage sludge of nature. In this case, however, the ratio of solid carbon to volatile constituents must be ensured. In many sewage sludges, volatile constituents of more than 50% by mass, which are no longer available at 900° C. for the reaction on the bottom of the rotary kiln, are found.

Therefore, it is not always possible to dispense with an addition of solid carbon.

The quartz sand alone must be added stoichiometrically. This pellet-like product mixture is then fed to a rotary kiln.

The highest phosphorus yields can be achieved with increasing temperature, for example at a temperature of 1,250° C. or more. The exposure time should not fall below twenty minutes at this temperature. The phosphorus discharge depends decisively on the precipitant and on the Fe: P mass ratio or molar ratio of iron to phosphorus. In the high-temperature process, it has been found that the Fe-based precipitants (mostly FeCl₃) and the high iron content caused thereby greatly limit the phosphorus discharge from the sewage sludge. The phosphorus discharge is linearly decreasing in mass ratio 2 of Fe: P. The higher the iron content, the lower the phosphorus discharge, so that the Fe: P molar ratio must be lower than 0.95 in the sewage sludge if one wishes to achieve a phosphorus discharge of more than 50% of the phosphorus present in the sewage sludge.

According to the invention, a phosphorus discharge of more than 80% by mass is achieved using the hard process in sewage sludge. The ratio of iron to phosphorus is the decisive criterion for the recovery of phosphorus sewage sludge. The less iron contained in the sewage sludge, the better the discharge of phosphorus.

The invention also relates to a device for carrying out this method. According to the invention, a rotary kiln is used which is equipped with a feed device for supplying sewage sludge.

Also provided are means for transporting away the slag.

The feed device is connected to a transport means, in particular at least one conveyor belt, for transporting pelletized or coke-shaped pre-dried sewage sludge to a rotary kiln and heating means for heating the sewage sludge in the rotary kiln and means for collecting phosphorus pentoxide and means for removing slag.

The invention is explained in more detail below in exemplary embodiments.

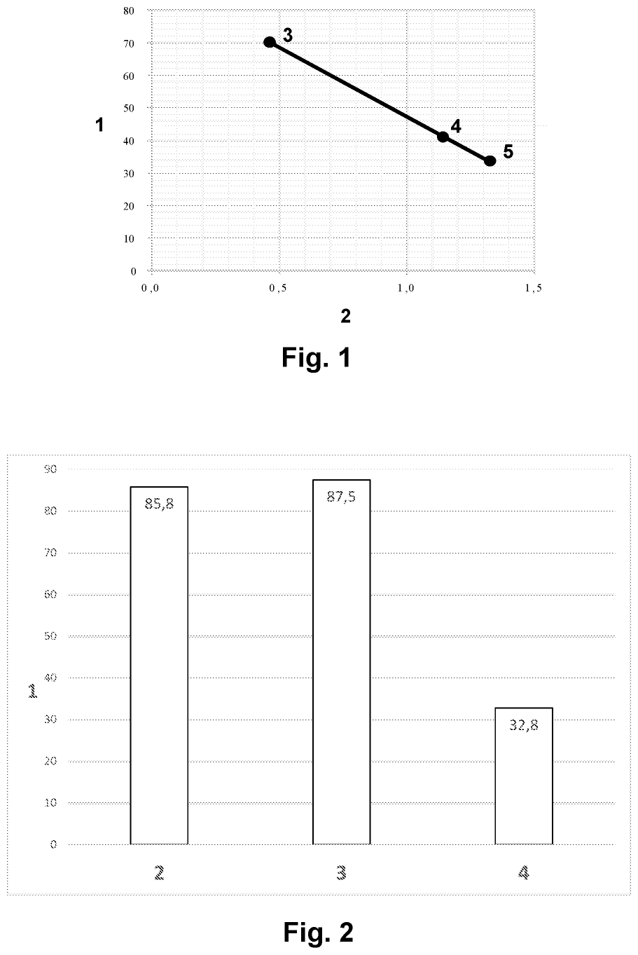

FIG. 1 shows the gaseous phosphorus discharge from sewage sludge in mass percent into the gas phase as a function of the molar ratio of iron to phosphorus in various sewage treatment plants,

FIG. 2 shows column representations of the percentage of phosphorus discharge as a function of the precipitant,

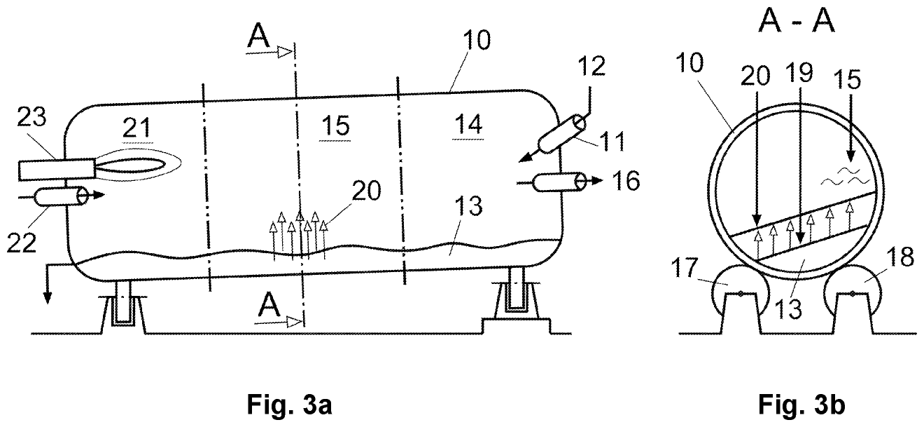

FIG. 3a shows a longitudinal section through rotary kiln filled with sewage sludge particles in a first embodiment,

FIG. 3b shows a cross section through the rotary kiln according to FIG. 3a along a section line A-A and

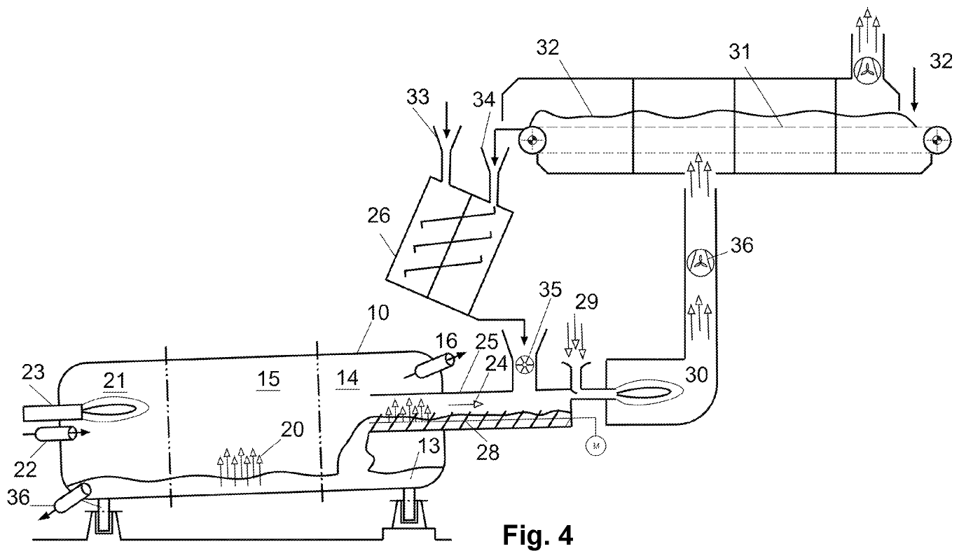

FIG. 4 shows a plant for feeding sewage sludge, carbon and silica to a rotary kiln and for producing phosphorus pentoxide and discharging a sewage sludge residue from which the phosphorus has been removed.

In the application of the thermal phosphorus discharge 1 (FIG. 1) from different sewage sludge above the mass ratio 2 of Fe : P, a straight line results which drops linearly. Thus, the iron concentration has a large, if not at all, the greatest influence on the degree of cleavage of the phosphates. FIG. 1 shows the results on the basis of various sewage treatment plants 3, 4 and 5. The higher the iron content, the lower the phosphorus discharge, as is obtained in particular in a rotary kiln.

For the present mechanism, a plausible explanation associated with the formation of iron phosphides was found: According to investigations of the Bundesanstalt fOr Materialforschung und -prüfung (Federal Institute for material research and testing (BAM)), phosphorus contents of 1.5 to 13.1% by mass are generally indicated for sewage sludge ashes. It is furthermore assumed that aluminum contents of 0.7 to 20.2% by mass, iron contents of 1.8 to 20.3% by mass and calcium contents of 6.1 to 37.8% by mass are present in the sewage sludge ash. Since these elements are used for phosphorus precipitation, they decisively influence the composition of the sewage sludge, while the apatite treated by the hard process consists mainly of calcium phosphate and the accompanying element fluorine. Structural investigations provided the detection that iron phosphides (Fe₂P and FeP), which have a low vapor pressure, are formed at high temperatures under reducing conditions. It is therefore assumed according to the invention that the low phosphorus yield is caused by the formation of iron phosphides. The invention is explained in more detail below in an exemplary embodiment with reference to the drawings, in which in FIG. 2 the results of the thermochemical phosphorus application of calcium-, aluminum-and iron-precipitated sewage sludge are carried out.

FIG. 2 shows a thermochemical phosphorus discharge 1 in percent of the phosphorus contained in the sewage sludge as a whole; in this case, the column 2 indicates the discharge of the phosphorus as calcium phosphate (Ca₃(PO)₄) when using calcium as a precipitating agent, column 3 indicates the discharge of the phosphorus as aluminum phosphate (AlPO₄) when using aluminum as a precipitating agent, and the column 4 indicates the discharge of the phosphorus as iron phosphate (FePO₄) when using iron as precipitating agent It is found that iron greatly reduces the effectiveness of the thermochemical phosphorus recovery.

If a precipitating agent based on aluminum is used, such as aluminum sulfate (Al₂(SO₄)₃ 18 H₂O), up to 87.5% phosphorus can be recovered by means of thermochemical high-temperature conversion. The residue has a phosphorus content of less than 20 g/kg. In view of the sludge prescription, the premise of the limit value with a phosphorus content of less than 20 g/kg of dry substance sewage sludge and a recovery degree of min 80% is maintained.

The preconditions for the use of thermal processes have been greatly aggravated by the novel sewage sludge prescription already cited above. Thus, for the recovery of phosphorus from sewage sludge, a process must be used which ensures a reduction of the phosphorus content by at least 50% or to less than 20 grams per kilogram of dry mass. At least 80% of the phosphorus must be recovered from ash or the carbonaceous residues which are obtained after a pretreatment of the sewage sludge (cf. paragraphs 3a-3 c AbfKlärV) [German Regulation].

Since sewage sludge in contrast to phosphate ore has higher diversity in the element composition, the recovery of a pure phosphorus-containing product is limited, for example, by heavy metals.

According to the invention, the process is carried out in a rotary kiln 10 (FIGS. 3a, 3b) according to the type of rolling process, as is known, for example, from EP 3 243 915A1 during use for recovering rolling oxide from zinc-containing raw materials.

The rolling work belongs to a number of processes in which the enrichment of the oxidic constituents to be recovered takes place via the formation of an intermediate metal phase with subsequent volatilization and reoxidation in the gas stream. The undesired residual materials remain predominantly in a highly viscous residue.

As a result of the rotation and as a result of an inclination with respect to the horizontal, the solid feed is gradually moved to the discharge end counter to the gas stream. The system thus functions in the so-called countercurrent principle. The exposure time of the feed material is dependent on the lining, the length, the inclination and the rotational speed of the rolling tube furnace. The material passes through the following three zones, a drying zone, a heating zone with a combustion of carbon-containing substance, a main reaction zone and a reoxidation zone.

Cooling feedstock is supplied via an inlet 11, for example with quartz sand, pelletized sewage sludge 12, for example via a chute, a product chute or a conveyor belt. The sewage sludge 12 has a humidity of not more and forms a bed 13 on the bottom of the rotary kiln 10, above which a hot furnace atmosphere is formed in a drying zone 14. As a result, free and bound water is evaporated, and the batch or the feed of the pelletized sewage sludge 12 is dried. Some proportions of carbon-containing volatile constituents from the sewage sludge 12 are already expelled from the drying zone 14. As a result of the temperature present in the rotary kiln 10 in the region above the drying zone 13, a combustion process takes place there exclusively in the furnace atmosphere above the bed 13 or at the contact surface between the furnace atmosphere and the bed 13. In a main zone 15, crude gas rich from the bulk material escapes into the furnace atmosphere and leaves the rotary kiln 10 on the inlet side via a draw-off tube 16 and is subjected to a multi-stage exhaust gas treatment for product extraction and purification.

The sewage sludge 12 introduced into the rotary kiln 10 can be in the form of sewage sludge coke, sewage sludge briquettes or sewage sludge pellets or as another granulate.

In this main zone 15, the reduction of the phosphorus compounds present in the bed 13 takes place. Since the phosphorus reduction is an endothermic process, the amount of carbon required in the rolling process does not depend on the amount stoichiometrically required for phosphorus reduction, but after the heat requirement of the process, for which reason carbon must be present significantly superstoichiometrically or must be added in the form of, for example, coke. The reducing agent carbon contained or added in the sewage sludge 12 first reacts with the atmospheric oxygen to form carbon dioxide which reacts with solid carbon according to the Boudouard reaction to carbon monoxide. The carbon monoxide may reduce the contained compounds of phosphorus. The rolling movement produced by the rotation of the rotary kiln 10 on rotary rollers 17, 18 supports this effect by constantly replacing the rolling movement with a contact zone 19 between the feed 13 and the furnace atmosphere in the main zone 15; as a result, starting from the drying zone 13, a discharge 20 of reoxidized phosphate into the gas phase takes place in the form of phosphorus pentoxide, forming slag. In order to maintain this process, the slag must not melt. As a result of this, additives which are intended to prevent melting are also introduced into the rotary kiln 10 when the sewage sludge 12 is introduced. Preferably, an excess of silica is added, forcing the formation of silicates. As a result of the prevailing process conditions—high temperature and sufficiently high vapor pressure—phosphorus is evaporated from the bed into the gas space. In the gas phase, the phosphorus vapors are reoxidized exothermically to phosphorus pentoxide. In addition to this reaction, the afterburning of the carbon monoxide contained in the furnace atmosphere also provides thermal energy, which is why the process gas continues to be heated. In parallel, the furnace atmosphere is already depleted of free oxygen.

In a reoxidation zone 21 adjoining the main zone 15 and also referred to as ash-forming region, cold oxygen-free air is supplied from an end face of the rotary kiln 10 via an inlet 22 in the countercurrent principle to air which impinges on the bed 13 heated there by a burner 23, as a result of which the air is heated. Metal compounds which are not evaporated in the product batch are reoxidized here. If, for example, iron components are present here, they would be reoxidized exothermically to give iron oxide. The SiO₂ component remaining for the reaction ensures that the ash cannot soften and baked.

The mixture of sewage sludge and additives required for the rotary kiln 10 has previously been micropelletized, for example. The rotary kiln 10 is inclined downwardly toward the burner 23 so that the bed 13, as the rotary kiln 10 slowly rotates, is gradually moved toward the burner 23. Below the burner 23, the bed 13 is discharged from the rotary kiln 10 again via an outlet 24 in the form of ash.

To cool the residue, it is passed through a cooler (not shown here). The heat removed from the residue in the cooler is simultaneously used for heating the inlet air supplied via the inlet 22 for the rotary kiln 10. The product gas or product vapor 4, in particular phosphorus pentoxide, escaping as discharge 20, after it has been removed from the rotary kiln 10 via the draw-off tube 16, is passed through a dedusting stage and a hydrator to form phosphoric acid and purified to produce product phosphoric acid.

The rotary kiln 10 is particularly suitable for the reduction of phosphate-containing sewage sludge, since it transfers the heat directly to a bed of pelletized feed particles. The rotary kiln 10 according to the invention is of conventional design; it has, for example, stationary end portions and a rotating central portion or cylinder which is provided with a suitable refractory material lined and connected thereto. When the burner 23 is arranged off-center on the end wall and the rotary kiln 10 also rotates in the region of the reoxidation zone 21, scale plates are arranged around the inlet of the burner 23 in the end wall, which prevent uncontrolled intake of air or an escape of phosphorus pentoxide from the interior of the rotary kiln 10.

Fuel and air or oxygen are supplied to the burner 23, so that the burner 23 generates a flame for the direct heating of the bed 13. In this context, the term “flame” is understood to mean either the luminous portions of an oxidation reaction, the hot gases or both associated therewith.

In order to initiate the process, a conventional fuel can be used to preheat the central part of the rotary kiln 10 and the bed 13, but since the reaction in the bed 13 produces elemental phosphorus vapor and carbon monoxide burned in the main zone 15 to be referred to as the oxidation zone, less fuel is required as soon as the process is in operation. Sufficient air or oxygen must be provided in order to reliably oxidize the phosphorus and the carbon monoxide over the bed 15.

In summary, the following conditions can be defined for carrying out the method according to the invention:

The process requires a strongly reducing atmosphere in the product charge of the furnace and immediately above (oxygen freedom, presence of carbon monoxide).

In the free furnace chamber, an oxidizing atmosphere is required for maintaining the base reactions and for the safe post-combustion of elemental phosphorus to phosphorus pentoxide and of carbon monoxide to carbon dioxide.

The reactants of the phosphate, namely carbon and silicon dioxide, must be present in excess and well mixed.

The sewage sludge must not contain too much iron-this is often used as an efficient phosphorus precipitating agent, but the phosphorus from these compounds can hardly be dissolved out as determined by the invention. The presence of iron phosphate reduces the phosphorus evaporation rate to a low value.

Sewage sludges which have been treated with aluminum or calcium-based precipitants are better suited. Experiments with pure aluminum or calcium phosphate result in a very high evaporation rate of phosphorus.

The process temperature is above 1,200° C. preferably above 1,250° C.

The exposure time of the feed material, i.e., the bed 13, in the rotary kiln 10 at the highest temperature of 1,280° C. used here is at least twenty minutes, preferably between twenty and forty minutes. As a result, rapid heating to the process temperature r is achieved.

In a further embodiment of the invention (FIG. 4), sewage sludge 32 originating from a sewage treatment plant and pre-dried by a centrifuge to a moisture content of 75 to 80% is applied to a belt dryer 31, on which sewage sludge 32 is further dried at temperatures of 120 to 125° C. until it still has a residual moisture of about 10%. The sewage sludge particles 32 present on the conveyor belt 31 form, for example, a granulate.

Before they are fed to the rotary kiln 10, the sewage sludge particles 32 are additionally mixed with carbon particles and silicon dioxide particles supplied via a funnel 33, in particular in the form of quartz sand, to a mixer 26, the sewage sludge particles 32 themselves entering the mixer 26 via a funnel 34.

From the mixer 26, a sewage sludge mixture 28 formed thereby is fed via a cellular wheel sluice 35 to a conveyor screw 25, which introduces the sewage sludge particles 32 into the rotary kiln 10. The screw conveyor 25 projects into the interior of the rotary kiln 10 so that the sewage sludge particles 32 are already preheated before they fall down onto the bottom of the rotary kiln 10. The conveyor screw 25 projects approximately in the middle of the side wall of the rotary kiln 10 or in the lower third of the side wall of the rotary kiln 10 into the rotary kiln 10. By means of an imbricated seal, sufficient sealing of the interior of the rotary kiln 10 with respect to the outer region is achieved in this case.

The mass ratio of the phosphorus contained in the sewage sludge to silicon dioxide required for the admixture in the mixer 26 is determined continuously or preferably at time intervals after X-ray fluorescence analysis or ICP emission spectrometry (ICP OES) (=Induced-Coupled Plasma Optical Emission Spectrometry), i. e., in a method of optical emission spectrometry with inductively coupled plasma, to which portions phosphorus and silicon dioxide are already present in the sewage sludge, carbon being analyzed by coulometrically, for example, so that as much of carbon and silicon dioxide is supplied to the mixer 26 on the basis of this result until an at least stoichiometric ratio of the mass of the phosphorus to the mass of the carbon and to the mass of the silicon dioxide of 1: 1: 3 is achieved, that the silicon dioxide mixed with the sewage sludge if necessary and the carbon mixed with the sewage sludge if necessary are fed together with the sewage sludge mixture 28 to the rotary kiln 10 in such a way that the sewage sludge or sewage sludge, the mixture of the sewage sludge, the added silicon dioxide and the carbon added is subjected to a rolling process and the driven phosphorus is collected in the form of gaseous phosphorus pentoxide.

In a particularly advantageous manner, the addition of carbon and silicon dioxide is realized in that carbon and silicon dioxide are mixed with the sewage sludge in superstoichiometric masses until the ratio of the mass of phosphorus to the mass of the carbon and to the mass of the silicon dioxide of 1: 3 : 5 is achieved. In this way, a very high proportion of phosphorus, for example of 80%, can be removed from the sewage sludge mixture 28 in the rotary kiln 10, which is constructed as shown in FIG. 3.

As also shown in FIG. 3a, phosphorus oxide-rich raw gas formed in the furnace atmosphere leaves the rotary kiln 10 via the draw-off tube 16, which is arranged in the upper region of the end-side wall on the side opposite the burner 23.

At the same time, heated air leaves the rotary kiln 10 counter to the conveying direction of the sewage sludge mixture in the conveying screw 25 in countercurrent principle above the sewage sludge mixture 28 fed via the conveying screw 25, and the sewage sludge mixture 28 already preheated by the hot atmosphere of the rotary kiln 10 extracts the volatile hydrocarbons contained therein, which are sucked in by a fan 36 preferably together with externally supplied combustion air 29 in a combustion chamber 30; the exhaust gases are preferably conducted to the belt dryer 31 in order to support the heating of the sewage sludge particles 32 therein.

Residual sewage sludge, which has been largely removed from the phosphorus, is discharged from the rotary kiln 10 via an outlet 36.

1. Process for obtaining phosphorus from dried sewage sludge, wherein the mass ratio of the phosphorus contained in the sewage sludge is determined, that as much carbon and as much silicon dioxide are added to the sewage sludge until an at least stoichiometric ratio of the mass of the phosphorus to the mass of the carbon and to the mass of the silicon dioxide of 1: 1: 3 is achieved, that the silicon dioxide added to the sewage sludge if necessary and the carbon added to the sewage sludge if necessary are fed together with the sewage sludge to a rotary kiln, that the sewage sludge or mixture of the sewage sludge, of the added silicon dioxide and of the added carbon is subjected to a rolling process and the extracted phosphorus is collected in the form of gaseous phosphorus pentoxide.

2. Process according to claim 1, wherein the carbon and silicon dioxide are added to the sewage sludge in superstoichiometric masses until the ratio of the mass of the phosphorus to the mass of the carbon and to the mass of the silicon dioxide of 1: 3: 5 is achieved.

3. Process according to claim 1, wherein the sewage sludge is introduced into the rotary kiln in the form of sewage sludge coke, sewage sludge briquettes or sewage sludge pellets or as another granulate.

4. Process according to claim 1, wherein a bed formed on the bottom of the rotary kiln and formed from sewage sludge is reduced in a strongly reducing substance, in particular in an environment of carbon coke or in the presence of a reducing atmosphere, in particular in the absence of oxygen.

5. Process according to claim 4, wherein the process is carried out in the presence of carbon monoxide.

6. Process according to claim 1, wherein the sewage sludge is used which has previously been treated with an aluminium-based or a calcium-based precipitant.

7. Process according to claim 1, wherein the process temperature is above 1,200° C., in particular above 1,250° C.

8. Process according to claim 1, wherein the exposure time in the rotary kiln does not fall below a period of twenty minutes, in particular at a temperature of 1,280° C.

9. Process according to claim 1, wherein the heating process takes place within ten minutes, in particular within less than five minutes.

10. Device for carrying out the method according to claim 1 using a rotary kiln, wherein it comprises transport means, in particular at least one conveyor belt, for transporting pelletized or coke-shaped pre-dried sewage sludge to the rotary kiln and heating means for heating the sewage sludge in rotary kiln and means for collecting phosphorus pentoxide and means for removing slag.

11. Device according to claim 10, wherein the sewage sludge in the form of sewage sludge particles is conveyed via a belt dryer to a mixing plant comprising a mixer, in which carbon particles and quartz sand are mixed in the sewage sludge particles as required to obtain a stoichiometric mass ratio of the mass of the phosphorus in the sewage sludge particles, or in that contain carbon and silicon dioxide are added in superstoichiometric masses to the sewage sludge particles until the ratio of the mass of the phosphorus of 1: 3 : 5 to the mass of the carbon and to the mass of the silicon dioxide is reached.

12. Device according to claim 11, wherein a sewage sludge mixture obtained from the mixer is introduced into the rotary kiln via a screw conveyor, in particular via a cellular wheel sluice.

13. Device according to claim 10, wherein phosphorus-containing raw gas, in particular phosphorus pentoxide, produced in the rotary kiln is led out of the rotary kiln via an outlet.
